(19) United States
(12) Patent Application Publication
(10) Pub. No.: US 2002/0166859 A1
(43) Pub. Date: Nov. 14, 2002

(54) Tank vent cap

(76) Inventor: Henry E. McGrew JR., Benton, LA (US)

Correspondence Address: John M. Harrison, 2139 E. Bert Kouns, Shreveport, LA, 71105, US

(21) Appl. No.: 09/854,117

(22) Filed: May 14, 2001

(51) Int. Cl. B65D 51/16; F16L 57/00

(52) U.S. Cl. 220/366.1; 138/96 R

(57) ABSTRACT

A tank vent cap for seating on the gas exhaust or vent pipe of a tank such as a sewage treatment system tank and preventing entry of rainwater, debris or animals into the pipe while facilitating the escape of gas, typically air, from the pipe. In a preferred embodiment, the tank vent cap is characterized by a cylindrical cap wall having inside, radially spaced-apart vent indentations formed therein and fitted with tabs located on the underside of the cap top. When the cap is placed on the air exhaust or vent pipe, the tabs of the cap engage the top edge or lip of the pipe to define top air passages between the pipe lip and the underside of the cap top. The vent indentations define side air passages between the outside surface of the pipe wall and the inside surface of the cap wall, which side air passages communicate with the top air passages. The tank vent cap can be quickly and easily removed and replaced on the pipe in a friction-fit, without the use of bolts or other fasteners.

### BACKGROUND OF THE INVENTION

1. Field of the Invention

This invention relates to air or gas circulation treatment tanks such as sewage treatment system tanks and other tanks and/or vent or exhaust pipes requiring the emission of gas, and typically air, for operation. More particularly, the invention relates to a sewage treatment tank or alternative air circulation tank vent cap which fits over the usually vertically-oriented air or gas exhaust or vent pipe in a friction-fit for closing the exhaust or vent pipe and exhausting air from the tank.

Sewage treatment systems frequently require the use of a cylindrical, sub-surface, water-filled treatment tank, typically having one or more downwardly-extending air drop lines or other air lines connected to an air distribution system for introducing air into the treatment tank. Each of the drop lines is oriented for introducing air into the turbulent or aeration zone or chamber of the treatment tank, between the tank wall and the clarifier, at an optimum rate and bubble distribution to optimize the dissolved oxygen content of the water in the tank. This arrangement facilitates handling a wide variety of organic loading to achieve an optimum biological balance in the treatment tank. The air which bubbles through the effluent in the tank typically reaches the surface of the effluent and is exhausted from the tank through an air exhaust or vent pipe in the top of the tank.

One of the problems realized in maintaining a treatment tank air exhaust or vent pipe in a preferably vertical orientation without a cap or lid, is the intrusion of rainwater and other debris such as small sticks, leaves and the like, and even small animals into the tank through the air exhaust or vent pipe. Another problem is the requirement for removing, and then replacing, bolts or other fasteners which maintain conventional caps and lids in place on the air exhaust or vent pipe.

2. Description of the Prior Art

Various types of caps for sewer pipes an the like are known in the art. An early such cap is detailed in U.S. Pat. No. 510,884, dated Dec. 19, 1893, to H. Bradley, Jr., which includes a cap for fitting over the open upper end of a vertical sewer pipe and having a bolt extending downwardly from the center of the cap for engagement with a receiving flange in the pipe, to maintain the cap in position on the pipe. U.S. Pat. No. 2,601,820 dated Jul. 1, 1952, to L. N. Paul, et al., details a “Vent Pipe Cap” which includes a dual-compartmented cap, one compartment of which fits over a vertically-oriented pipe, wherein air from the pipe can be diffused into the second compartment and exited into the atmosphere. U.S. Pat. No. 2,791,941, dated Feb. 19, 1957, to G. W. Lindsey, details a “Vertical Vent Fitting” which includes a shaped cap fitted to a wedge-shaped vent fitting and maintained in place by a bolt. The vent fitting fits tightly over the vertical open end of a pipe and is seated thereon by means of a set screw or bolt. Accordingly, either the vent fitting or the cap may be periodically removed, as desired. U.S. Pat. No. 3,031,783, dated May 1, 1962, to G. J. Burke, details a vent cap for mounting on a vertically-oriented pipe using bolts or set screws and having spaced-apart, downwardly-projecting shoulders for seating on the top edge of the vent cap and providing air passageways for exit of the air from the pipe through the cap to the atmosphere. U.S. Pat. No. 3,469,520, dated Sep. 30, 1969, to L. A. Foy, et al., details a “Vent Cap” suitable for receiving a sign thereon, which vent cap has multiple flanges that are threaded for receiving bolts to maintain the cap in position on an upward-standing pipe. U.S. Pat. No. 4,399,743, dated Aug. 23, 1983, to Izzi, Sr., details a “Vent Pipe Cap” for use on vent stack pipes of various size, which cap is fitted with a downwardly-extending bolt for attachment to a plate which is bolted to the upper end of a vertically-oriented vent pipe, the cap having serrated or stepped shoulders for fitting on vent pipes of different sizes. U.S. Pat. No. 5,081,914, dated Jan. 21, 1992, to A. G. Mejia, details a “Roof Vent Cap” that can be attached to a roof vent pipe to form a closure for the pipe after a conventional ventilating device attached to the pipe has been removed. The roof vent pipe is typically of a one-piece or unitary construction and is secured in place by anchor screws.

It is an object of this invention to provide a new and improved vent cap for closing or capping gas vent pipes such as air exhaust or vent pipes on treatment tanks and allowing gas or air to escape from the vent or exhaust pipes, which cap includes multiple, spaced-apart inside wall indentations and tabs on the inside top surface of the cap for engaging the vent or exhaust pipe and facilitating passage of air from the vent or exhaust pipe between the pipe and the tank vent cap, to the atmosphere.

Another object of this invention is to provide a new and improved tank vent cap for closing and venting air exhaust or vent pipes of various description, which tank vent cap is typically of a generally cylindrical configuration, having a top and is provided with at least one vent indentation in the periphery of the inside wall surface of the cap and at least one tab provided in the inside top surface of the cap and offset from the indentation or indentations, to define air passages and facilitate a flow of air from the air exhaust or vent pipe through the air passages, to the atmosphere.

Still another object of the invention is to provide a tank vent cap for venting typically vertically-oriented vent lines and pipes such as the air exhaust or vent pipes of sewage treatment tanks, which tank vent cap includes a cap top that closes a cylindrical cap wall, the inside surface of which cap wall is fitted with multiple, radially-disposed, preferably spaced-apart vent indentations, and which tank vent cap further includes multiple, spaced-apart tabs provided on the inside surface of the cap top, such that the tabs contact the top lip or edge of the air exhaust or vent pipe to support the tank vent cap thereon in a friction-fit with the cap top disposed in raised relationship with respect to the top lip or edge of the pipe, and the vent indentations lie in adjacent, spaced-apart relationship to the outside surface of the air exhaust or vent pipe to define discrete connecting air passageways, thus facilitating a flow of air from the air exhaust or vent pipe through the air passageways defined by the air exhaust pipe lip and the cap top and on through the air passageways defined by the outside surface of the pipe and the vent indentations, to the atmosphere.

### SUMMARY OF THE INVENTION

These and other objects of the invention are provided in a new and improved tank vent cap for venting vessels and tanks such as sewage treatment tanks which require the venting of air and/or other gases, which tank vent cap is designed to friction-fit on the typically vertically-oriented air exhaust or vent pipe extending from the top of the tank. In a preferred embodiment, the tank vent cap is characterized by a cylindrical cap wall closed on one end or edge by a cap top, which cap wall includes repetitive, radially-disposed vent indentations in the inside surface thereof, the vent indentations extending along the height of the cap wall to the cap top, and further including multiple tabs disposed on the inside surface of the cap top, preferably in staggered relationship with respect to the vent indentations, such that connecting air passageways are defined between the vent indentations and the outer surface of the wall of the air exhaust or vent pipe and between the cap top and the upper lip or edge of the pipe, to facilitate a flow of air through these connecting air passageways, to the atmosphere while preventing entry of rainwater, debris or animals into the pipe.

### BRIEF DESCRIPTION OF THE DRAWINGS

The invention will be better understood by reference to the accompanying drawings, wherein:

FIG. 1 is a perspective view of a typical treatment tank such as a sewage treatment tank, fitted with an upward-standing air exhaust or vent pipe in the top thereof, with the tank vent cap of this invention closing the pipe;

FIG. 2 is an enlarged, exploded view of the tank vent cap of this invention and the tank air exhaust or vent pipe and the treatment tank (partially in section);

FIG. 3 is a perspective bottom view of a preferred inside configuration of the tank vent cap illustrated in FIGS. 1 and 2;

FIG. 4 is a transverse sectional view of the tank vent cap illustrated in FIG. 3;

FIG. 5 is a sectional view taken along line 5-5 of the tank vent cap illustrated in FIG. 4; and

FIG. 6 is a sectional view taken along line 6-6 of the tank vent cap illustrated in FIG. 4.

### DESCRIPTION OF THE PREFERRED EMBODIMENTS

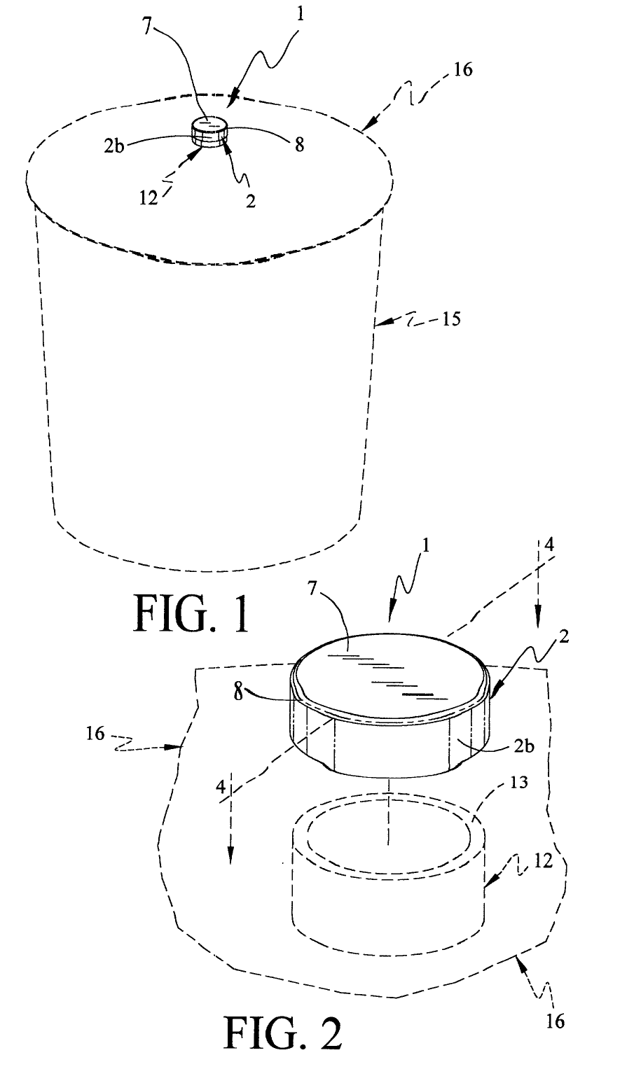

Referring initially to FIGS. 1 and 2 of the drawings, the tank vent cap of this invention is generally illustrated by reference numeral 1 and is typically installed on the top extending end of a vertical air exhaust or vent pipe 12, projecting from the tank top 16 of a tank 15, illustrated in phantom. The tank vent cap 1 is typically cylindrical in configuration and includes a cylindrical cap wall 2, defining a curved outside wall surface 2b the upper edge of which terminates at a typically flat cap top 7, typically at a top bevel 8. The tank 15 may typically be a sewage treatment tank or other tank wherein a gas such as air is introduced into the tank for purposes of treating the effluent therein or for other purposes known to those skilled in the art. The air or other gas discharged and not absorbed by the effluent in the tank 15 or otherwise passing through the tank 15 is exhausted through the air exhaust or vent pipe 12 in the tank top 16 and between the air exhaust or vent pipe 12 and the tank vent cap 1, as hereinafter further described. The tank vent cap 1 thus prevents rainwater, debris and other refuse and pollutants, as well as small animals, from entering the air exhaust or vent pipe 12 and the tank 15 while facilitating effusion of air or other gas from the interior of the tank 15 through the air exhaust or vent pipe 12.

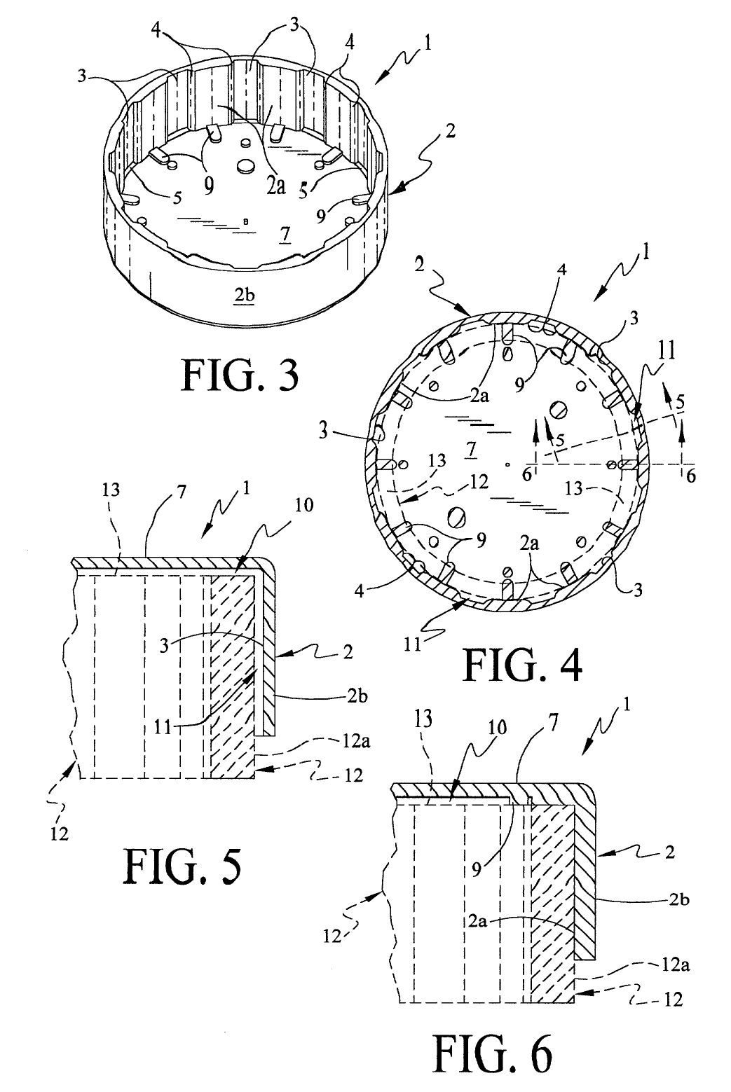

Referring now to FIGS. 3-6 of the drawings, in a preferred embodiment of the invention the interior of the cylindrical tank vent cap 1 is characterized by an inside wall surface 2a which typically includes multiple, radially spaced-apart vent indentations 3, each extending throughout the height of the outside wall surface 2a, from the open edge thereof, to an indentation base 5 at the cap top 7. In a preferred embodiment of the invention, each of the vent indentations 3 typically includes a pair of parallel, bevelled edges 4. When the tank vent cap 1 is placed on the air exhaust or vent pipe 12 as illustrated in FIG. 5, the vent indentations 3 are disposed in spaced-apart relationship with respect to the outside wall surface 12a of the air exhaust pipe 12 to define multiple, spaced-apart side air passageways 11. The number and size requirements of the vent indentations 3 depend upon the volume of air or gas to be exhausted from the tank 15 per unit of time, or the gas or air flow rate through the air exhaust or vent pipe 12.

Referring again to FIGS. 3, 4 and 6 of the drawings, multiple tabs 9 extend downwardly from the inside surface of the cap top 7 in spaced-apart relationship with respect to each other. In another preferred embodiment of the invention, the tabs 9 are located adjacent to the inside wall surface 2a of the cap wall 2 and are staggered with respect to the respective vent indentations 3, as illustrated in FIGS. 3 and 4. Accordingly, as further illustrated in FIGS. 5 and 6, when the tank vent cap 1 is placed on the extending end or pipe edge or lip 13 of the air exhaust or vent pipe 12, the downwardly-extending tabs 9 rest on the pipe lip 13 (FIG. 2), such that the cap top 7 is disposed in raised relationship with respect to the pipe lip 13. Thus, top air passageways 10 are defined between the continuous pipe lip 13 and that portion of the inside surface of the cap top 7 disposed between the respective tabs 9, as particularly illustrated in FIG. 5. Since the top air passageways 10 communicate with the side air passageways 11 as further illustrated in FIG. 5, air or gas flowing upwardly through the air exhaust or vent pipe 12 from the tank 15 illustrated in FIG. 1, is permitted to first flow through the top air passageways 10 and then through the connecting side air passageways 11, to the atmosphere. As illustrated in FIG. 6, the inside wall surface 2a of the cap wall 2 snugly engages the outside wall surface 12a of the air exhaust or vent pipe 12, between the respective vent indentations 3 to removably friction-fit the tank vent cap 1 on the air exhaust or vent pipe 12,

Referring again to the drawings, as heretofore described, it will be appreciated that the size, depth and number of the respective vent indentations 3 may be chosen, depending upon the flow rate of air or other gas required through the air exhaust or vent pipe 12, and the bevelled edges 4 of the vent indentations 3 serve to increase the flow volume or space of the side air passageways 11. Furthermore, the number and height of the tabs 9 chosen for projection from the cap top 7 in spaced-apart relationship with respect to each other is also selective, this number and height being critical only in providing top air passageways 10 of appropriate volume or space for the air or gas flow, and properly supporting and stabilizing the tank vent cap 1 on the pipe lip 13 of the air exhaust or vent pipe 12 in a secure friction-fit, as illustrated, in FIG. 6.

In a most preferred embodiment of the invention, the tank vent cap 1 is injection-molded of a plastic material such as polypropylene or polyethylene, in non-exclusive particular, with the vent indentations 3 and the tabs 9 molded in the cap wall 2 and cap top 7, respectively, according to the knowledge of those skilled in the art. Furthermore, since the tank vent cap 1 is not secured to the air exhaust or vent pipe 12 by any fastener or fasteners, the inside diameter of the inside wall surface 2a of the vent cap 1 is chosen such that a snug friction-fit is obtained between the inside wall surface 2a and the outside wall surface 12a of the air exhaust or vent pipe 12. Moreover, as heretofore described, the height and number of the tabs 9 on the cap top 7, as well as the width, depth and number of the respective vent indentations 3, can be chosen such that a sufficient air flow is maintained through the respective connecting top air passageways 10 and side air passageways 11, to the atmosphere.

It will be appreciated by those skilled in the art that while the tank vent cap 1 of this invention in a preferred embodiment is cylindrical to match the shape of a typically circular or cylindrical air or exhaust or vent pipe 12, the tank vent cap 1 can be designed in any desired cross-sectional configuration, typically any polygon, to achieve such a match, with the tabs 9 and vent indentations 3 in place as heretofore described, to effect the intents and purposes of the invention.

Accordingly, while the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A vent cap for engaging a vent pipe and allowing air to flow from the vent pipe to the atmosphere, said vent cap comprising a cap wall; a cap top closing said cap wall; a tab provided on said cap top for defining a first air passageway with the vent pipe; a vent indentation provided in said cap wall for defining a second air passageway with the vent pipe, said first air passageway connected to said second air passageway, whereby air flowing through the vent pipe flows through said first air passageway and said second air passageway, respectively, to the atmosphere.

2. The vent cap of claim 1 wherein said tab comprises a plurality of tabs disposed in spaced-apart relationship with respect to each other in said cap top and said first air passageway defines a set of air passageways.

3. The vent cap of claim 1 wherein said vent indentation comprises a plurality of vent indentations disposed in spaced-apart relationship with respect to each other in said cap wall and said second air passageway defines a set of air passageways.

4. The tank vent cap of claim 1 wherein:
(a) said tab comprises a plurality of tabs disposed in spaced-apart relationship with respect to each other in said cap top and said first air passageway comprises a first set of air passageways; and
(b) said vent indentation comprises a plurality of vent indentations disposed in spaced-apart relationship with respect to each other in said cap wall and said second air passageway comprises a second set of air passageways.

5. The tank vent cap of claim 4 wherein said vent indentations are staggered with respect to said tabs.

6. A tank vent cap for removably engaging and venting air from a tank and a tank exhaust or vent pipe extending from the tank and having a pipe edge and an outside wall surface, said tank vent cap comprising a generally cylindrically-shaped cap wall having an inside wall surface for engaging the outside wall surface of the pipe and a cap top closing said cap wall; a plurality of vent indentations provided in said inside wall surface of said cap wall in spaced-apart relationship with respect to each other; and at least one tab provided on said cap top for engaging the pipe edge of the pipe, whereby said vent indentations are spaced from the outside wall surface of the pipe to define a first set of air passageways and said cap top is spaced from the pipe edge of the pipe to define a second set of air passageways between said cap top and the pipe, said first set of air passageways connected to said second set of air passageways for channeling air from the tank and the pipe, through said first set of air passageways and said second set of air passageways of said tank vent cap, to the atmosphere.

7. The tank vent cap of claim 6 wherein said vent indentations are staggered with respect to said tabs.

8. A vent cap for venting an air exhaust or vent pipe having a top edge and an outside wall surface, said vent cap comprising a cylindrical cap wall having an inside wall surface; a cap top closing said cylindrical wall, said cap top having a bottom surface bordered by said cap wall; a plurality of tabs extending from said bottom surface of said cap top in spaced-apart relationship with respect to each other, said plurality of tabs adapted for contacting the top edge of the pipe and spacing said bottom surface of said cap top from the top edge of the pipe to define a plurality of top air passages; a plurality of vent indentations provided in said inside wall surface of said cylindrical cap wall, said vent indentations disposed in spaced-apart relationship with respect to each other for spacing said cap wall from the pipe to define a plurality of side air passages, whereby air is channeled through the pipe and through said plurality of top air passages and said plurality of side air passages, respectively, to the atmosphere.
